(19) United States
(12) Patent Application Publication
(10) Pub. No.: US 2004/0028825 A1
(43) Pub. Date: Feb. 12, 2004

(54) Coating of substrates prior to inkjet printing

(75) Inventor: Kevin Stone Manes, St. Charles, MO (US)

Correspondence Address: FOLEY AND LARDNER, SUITE 500, 3000 K STREET NW, WASHINGTON, DC, 20007, US

(73) Assignee: DELAWARE CAPITAL FORMATION, INC.

(21) Appl. No.: 10/452,918

(22) Filed: Jun. 3, 2003

Related U.S. Application Data
(60) Provisional application No. 60/384,408, filed on Jun. 3, 2002.

(51) Int. Cl. B05D 3/02

(52) U.S. Cl. 427/385.5; 118/300; 118/46

(57) ABSTRACT

A method of making a non-inkjet ready substrate suitable for inkjet printing. The method comprising providing a non-inkjet-ready substrate and applying a coating to the substrate. The coating provides a surface to which inkjet ink adheres with a selectable and substantially consistent texture and gloss level across the surface of the substrate.

This application claims the benefit of U.S. Provisional Application No. 60/384,408, filed Jun. 3, 2002.

### FIELD OF THE INVENTION

The present invention is directed generally to inkjet printing and specifically to the coating of substrates prior to inkjet printing.

### BACKGROUND OF THE INVENTION

Significant variation is observed in the appearance of inkjet printed images depending on the material on which the image is printed and the density of the ink. Some materials present a consistently matte image over the entire printed area, while others present a consistently glossy image over the entire printed area. Still other materials present a variation between matte an glossy at different points in the image. The first two cases, where the appearance is consistently matte or glossy, may not be acceptable, depending on the desired effect of the image. In the third case, the images are invariably mottled and unattractive in appearance.

Although the finish of images in general may vary depending on the substrate material and the ink density, the variation is particularly sensitive for inkjet inks. This is because inkjet inks, in order to be able to jet, have a lower viscosity and smaller pigment size than ordinary inks. Further, because of their lower viscosity and smaller pigment size, inkjet inks tend to easily saturate the substrate. This is especially true for the inexpensive substrate materials used in ordinary printing.

In order to avoid using expensive, specially formulated substrate materials, it would be advantageous to have a method of treating ordinary substrate materials to enable inkjet printing of an image having a selectable and consistent texture and gloss regardless of the substrate material or ink density. It would be particularly advantageous to have a method which is easily integrated into conventional printing processes.

### SUMMARY OF THE INVENTION

One embodiment of the present invention includes a coated substrate suitable for inkjet printing comprising a non-inkjet ready substrate and a coating providing a surface to which inkjet ink adheres with a selectable and substantially consistent texture and gloss level across the surface of the substrate.

Another embodiment of the present invention includes a method of making a non-inkjet ready substrate suitable for inkjet printing comprising providing a non-inkjet ready substrate, and applying a coating to the substrate, the coating providing a surface to which inkjet ink adheres with a selectable and substantially consistent texture and gloss level across the surface of the substrate.

Another embodiment of the present invention includes a method of inkjetly printing with a non-inkjet ready substrate comprising providing a non-inkjet ready substrate, applying a coating to the substrate, the coating providing a surface to which inkjet ink adheres with a selectable and substantially consistent texture and gloss level across the surface of the substrate, and applying inkjet ink to the coating to form a printed image.

Another embodiment of the present invention includes an apparatus for inkjet printing with non-inkjet ready substrates comprising a coating station adapted to coat the non-inkjet substrates with a coating that provides a surface to which inkjet ink adheres with a selectable and substantially consistent texture and gloss level across the surface of the substrate, and a printing station adapted to apply inkjet ink to coated non-inkjet substrates.

### BRIEF DESCRIPTION OF THE DRAWINGS

The foregoing and other features, aspects and advantages of the present invention will become apparent from the following description, appended claims and the exemplary embodiments shown in the drawings, which are briefly described below. It should be noted that unless otherwise specified like elements have the same reference numbers.

FIG. 1 is an image printed on uncoated Fasson Cast Gloss KromeKote Label Stock™.

FIG. 2 is an image printed on uncoated Fasson Fasclear™.

FIG. 3 is an image printed on Alden and Ott UV Flexo MA Opaque White™ coated Fasson Fasclear™.

FIG. 4 is an image printed on Alden and Ott UV Flexo MA Opaque White™ coated Matte Litho Label Stock™.

FIG. 5 is an image printed on Alden and Ott UV Flexo MA Opaque White™ coated Fasson Cast Gloss KromeKote Label Stock™.

FIG. 6 is an image printed on Akzo Nobel UVF Flexcure Hot Stamp Primer™ coated Fasson Fasclear™.

FIG. 7 is an image printed on Akzo Nobel UVF Flexcure Hot Stamp Primer™ coated Matte Litho Label Stock™.

FIG. 8 is an image printed on Akzo Nobel UVF Flexcure Hot Stamp Primer™ coated Fasson Cast Gloss KromeKote Label Stock™.

FIG. 9 is an image printed on Akzo Nobel UVF Hot Stampable Varnish™ coated Fasson Fasclear™.

FIG. 10 is an image printed on Akzo Nobel UVF Hot Stampable Varnish™ coated Matte Litho Label Stock™.

FIG. 11 is an image printed on Akzo Nobel UVF Hot Stampable Varnish™ coated Varnish™ coated Fasson Cast Gloss KromeKote Label Stock™.

FIG. 12 is an image printed on Sericol 800 UV Flexo Opaque White™ coated Fasson Fasclear™.

FIG. 13 is an image printed on Sericol 800 UV Flexo Opaque White™ coated Matte Litho Label Stock™.

FIG. 14 is an image printed on Sericol 800 UV Flexo Opaque White™ coated Fasson Cast Gloss KromeKote Label Stock™.

FIG. 15 is an image printed on Sericol 810 Mixing Clear™ coated Fasson Fasclear™.

FIG. 16 is an image printed on Sericol 810 Mixing Clear™ coated Matte Litho Label Stock™.

FIG. 17 is an image printed on Sericol 810 Mixing Clear™ coated Fasson Cast Gloss KromeKote Label Stock™.

FIG. 18 is an image printed on Sicpa D-9992-UV UV Gloss Imprintable Varnish™ coated Fasson Fasclear™.

FIG. 19 is an image printed on Sicpa D-9992-UV UV Gloss Imprintable Varnish™ coated Matte Litho Label Stock™.

FIG. 20 is an image printed on Sicpa D-9992-UV UV Gloss Imprintable Varnish™ coated Fasson Cast Gloss KromeKote Label Stock™.

FIG. 21 is a schematic view of a flexographic print apparatus according to an embodiment of the invention.

### DETAILED DESCRIPTION OF THE PREFERRED EMBODIMENTS

The inventors have determined that by applying a coating with the appropriate properties (discussed in more detail below), substrates which are not normally suitable for inkjet printing may be made suitable. That is, by selecting the appropriate combination of coating and ink, the finish (matte, glossy or any level in between) may be selected. Further, images may be inkjet printed which have consistent texture and gloss throughout the image. Additionally, in embodiments in which the image is primarily printed on the coating, the finish may be essentially independent of the underlying substrate material.

Without being held to any particular theory, it is believed that the use of very absorbent substrates results in the matte finish. These materials tend to absorb low viscosity ink beneath the uneven surface of the substrate, leaving little visible pigmentation on the refractive surface of the substrate. The second case occurs with substrate materials which are non-absorbent, leaving all the pigmentation on the surface and allowing the ink to flow to a smooth, reflective texture prior to curing. The third case is described by semi-absorbent materials which partially absorb ink in low density areas, but saturate in high ink density areas, leaving some ink on the surface to flow out prior to curing.

The terms substrates and coatings in the present application include both clear and colored materials. In the present application, clear materials may also include translucent materials. Further, for the purposes of this application, the term color includes white.

Typically, clear materials for both substrates and coatings are polymer based. Example polymer film substrate materials include, but are not limited to, polyethylene, polypropylene, polyester and polyolefin. Color substrate materials are typically made of paper but may be any woven or non-woven fiber material.

In an embodiment of the invention, the coating is applied to the substrate in a liquid form. To apply the coating, any suitable technique may be used. Example coating techniques include dip coating, spray coating and flexographic printing.

After applying the liquid coating, the coated substrate may be given a post coating treatment to solidify the coating. Typically, polymer based coatings are cured to set the coating. Curing may be conducted by exposing the coated substrate to UV light, heat or any other suitable curing technique. Non-polymer based coatings generally include a solvent. Typically, these films are treated by drying. Drying may be conducted by applying heat, vacuum or any other suitable drying technique.

After curing or drying, the substrate is ready for printing. In a preferred embodiment of the invention, an image is printed on the substrate by inkjet printing. However, an image may be printed on the coated substrate using any suitable printing technique. Other printing techniques include, but are not limited to gravure printing, relief printing, offset printing and flexographic printing.

In one embodiment of the present invention, the coating is selected based a combination of several parameters. These parameters include the adherence of the ink, surface tension, wetting, scuff resistance and light degradation. The adherence is dependent on the particular application. The surface tension and the wetting of the ink on the coating determine the finish of the image. Thus, these parameters are typically determined after the desired finish is selected. As with adherence, the scuff resistance and light degradation are dependent on the particular application. Determination of the various individual parameters may be accomplished by any suitable technique.

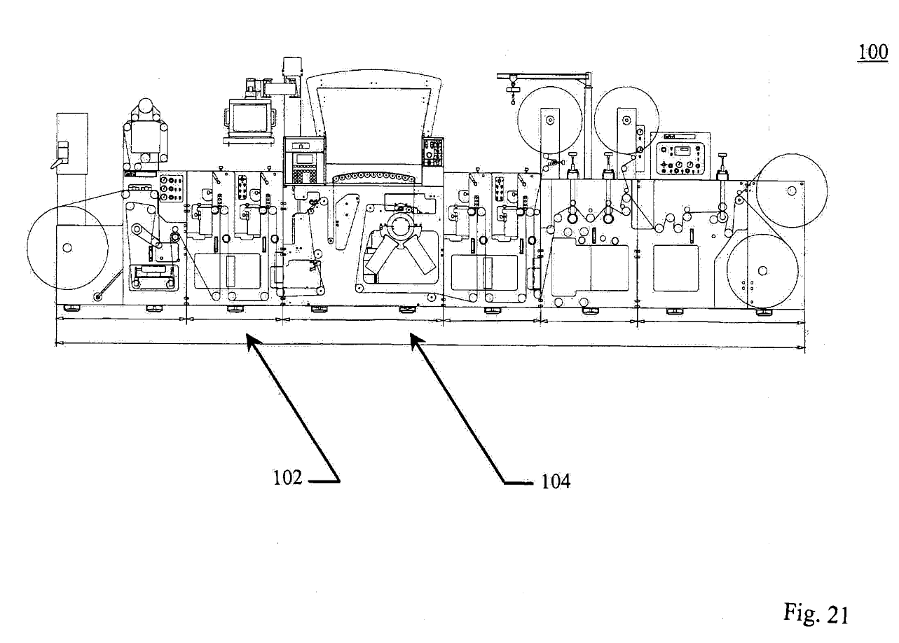

FIG. 21 illustrates another embodiment of the invention. In this embodiment, a combined coating-printing apparatus 100 is fabricated by combining a coating station 102 with an inkjet printing station 104.

In one aspect of the invention, the coating station 102 is a conventional flexographic printing station adapted to coat substrates with above disclosed coating materials.

### WORKING EXAMPLES

Tests were conducted with three commercial substrate materials: (1) Fasson Fasclear™, (2) Fasson Cast Gloss KromeKote Label Stock™, and (3) Matte Litho Label Stock™. Five commercially available coating materials used: (1) Sericol 800 UV Flexo Opaque White™, (2) Sericol 810 Mixing Clear™, (3) on Akzo Nobel UVF Flexcure Hot Stamp Primer™, (4) Akzo Nobel UVF Hot Stampable Varnish™, (5) Sicpa D-9992-UV UV Gloss Imprintable Varnish™ and one specially prepared formulation, Alden and Ott UV Flexo MA Opaque White™. All the images of the working examples were printed with a flexographic print station.

In these examples, the coating materials were metered with a 180 line 8.0 bcm anilox roll. The coatings were applied at a volume per unit area of 8.0 billion cubic microns/square inch. However, any value may be used as long as a sufficient amount of coating is applied to the substrate.

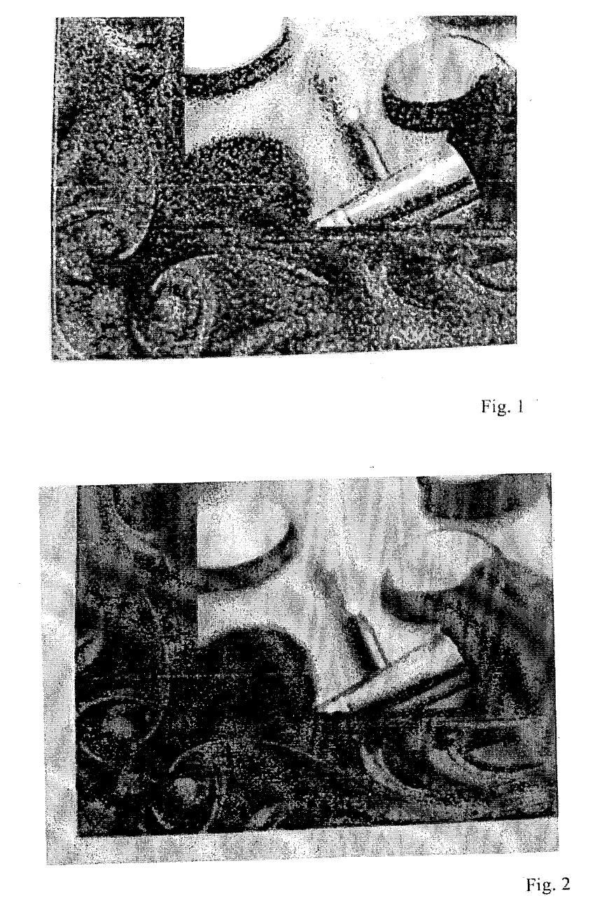

FIGS. 1 and 2 illustrate images using prior art printing methods. FIG. 1 illustrates an image printed on uncoated white label material (Fasson Cast Gloss KromeKote Label Stock™) while FIG. 2 illustrates an image printed on uncoated clear film (Fasson Fasclear™). The Cast Gloss is a semi-absorbent material and shows a typically mottled appearance. In contrast, the Fasclear™ material is non-absorbent and always results in a glossy finish.

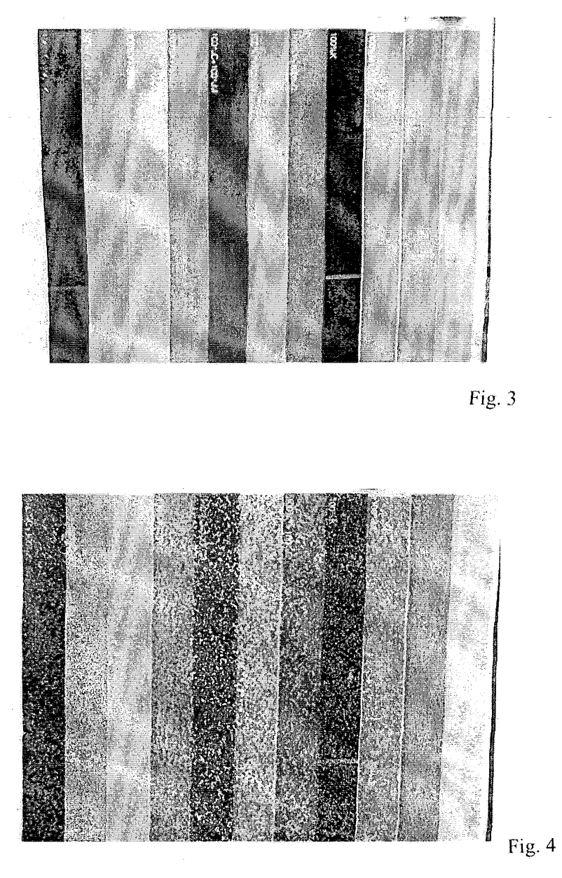

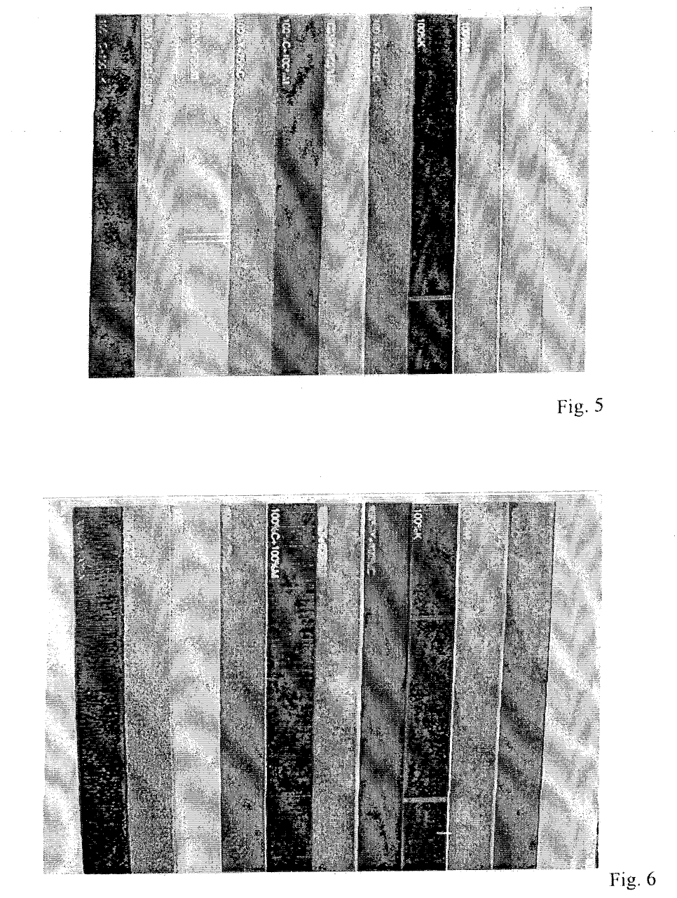

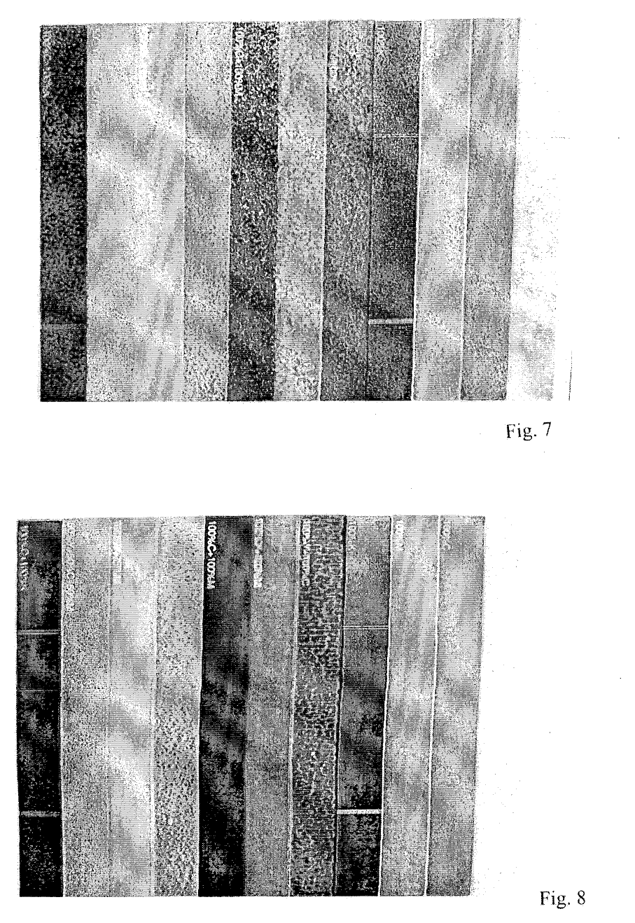

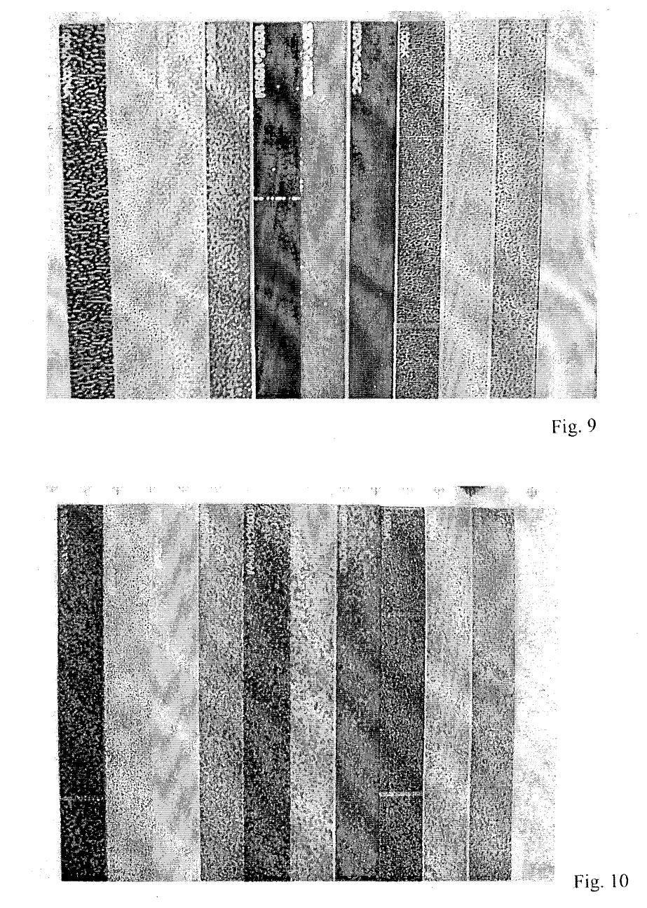

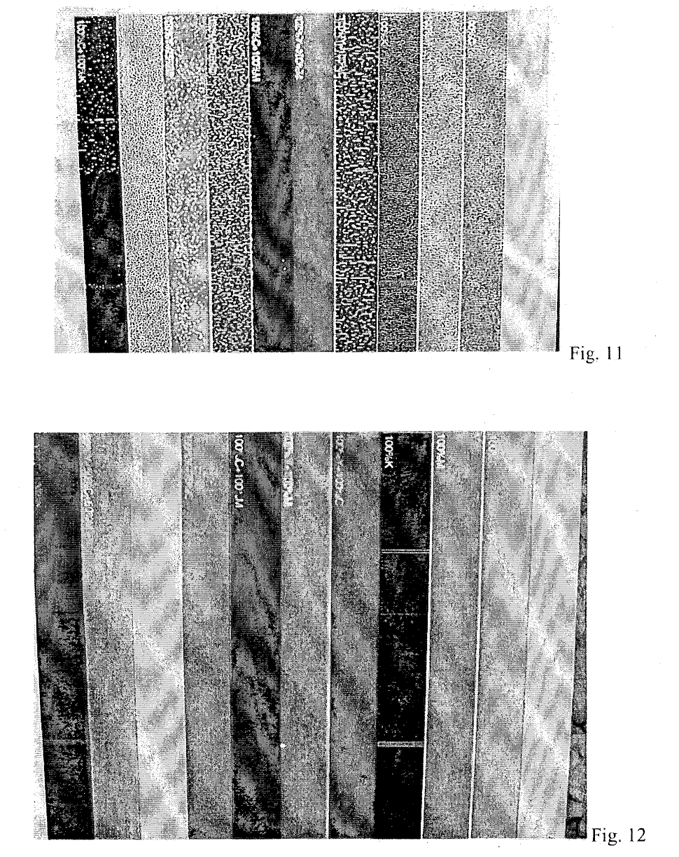

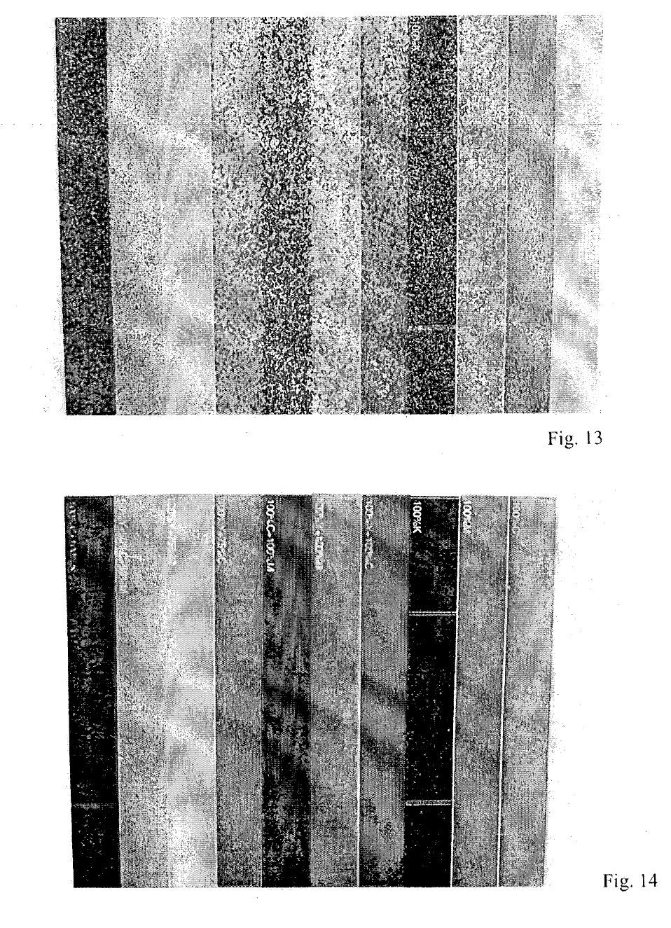

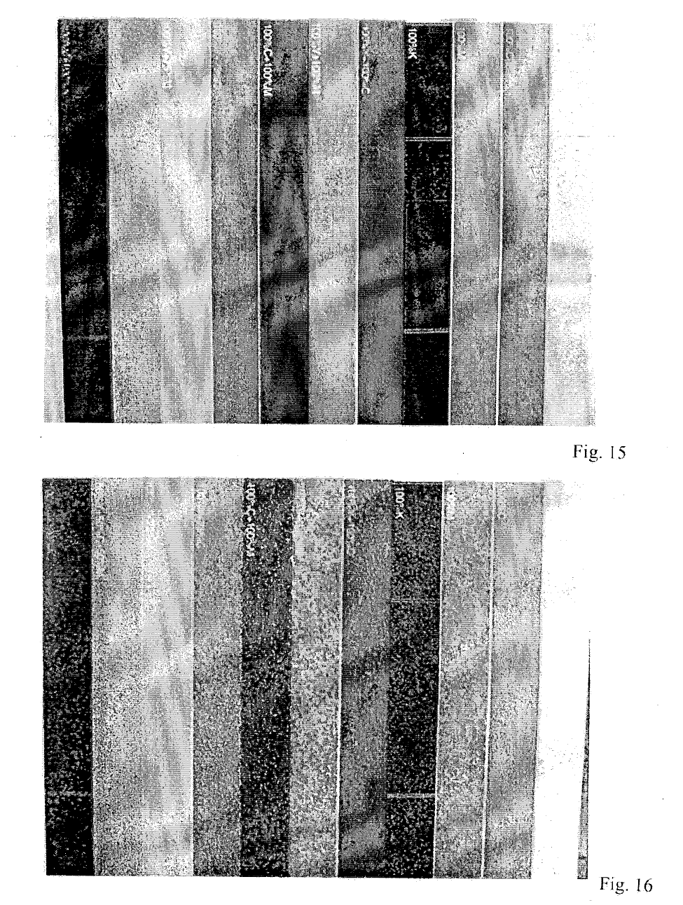

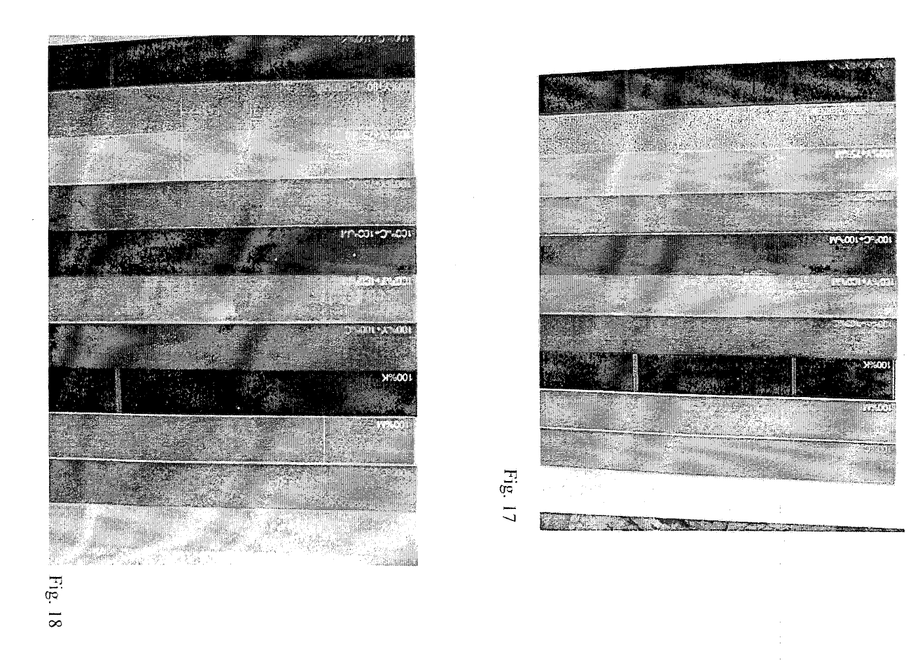

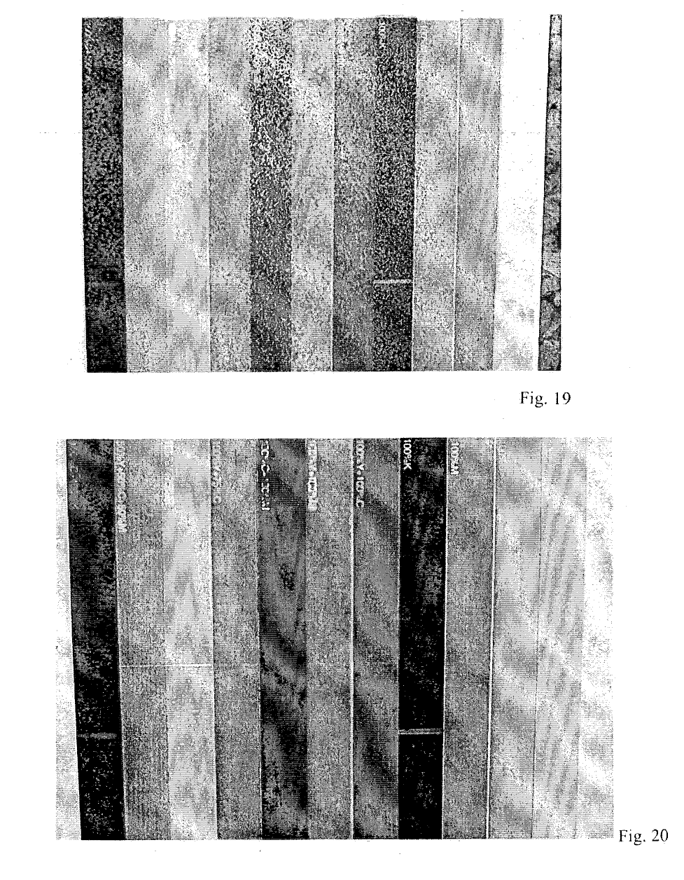

The results of tests of the six coatings on the three substrate materials are illustrated in FIGS. 3-20 and summarized in the table below.

| | | Material | | |
|---|---|---|---|---|
| Coating | Measurement | Fasclear | Matte Litho | Cast Gloss |
| Sicpa | Pin Hole | 3 Rank 2 | 4 Rank 3 | 5 Rank 2 |
| Varnish | Dot | 2 | 2 | 2 |
| | Mottling | 1 | 3 | 2 |
| Rank 1 | Density | 3 | 3 | 2 |
| Alden & Ott | Pin Hole | 4 Rank 3 | 5 Rank 5 | 2 Rank 1 |
| White | Dot | 4 | 4 | 1 |
| | Mottling | 2 | 6 | 1 |
| Rank 2 | Density | 2 | 5 | 1 |
| Akzo Nobel | Pin Hole | 6 Rank 6 | 1 Rank 4 | 6 Rank 6 |
| H/S Varnish | Dot | 6 | 5 | 6 |
| | Mottling | 6 | 4 | 6 |
| Rank 6 | Density | 6 | 4 | 6 |
| Akzo Nobel | Pin Hole | 5 Rank 5 | 3 Rank 1 | 3 Rank 5 |
| H/S Primer | Dot | 4 | 1 | 4 |
| | Mottling | 5 | 1 | 5 |
| Rank 5 | Density | 5 | 1 | 5 |
| Sericol 800 | Pin Hole | 1 Rank 1 | 6 Rank 6 | 4 Rank 3 |
| White | Dot | 1 | 6 | 3 |
| | Mottling | 3 | 5 | 3 |
| Rank 3 | Density | 1 | 6 | 3 |
| Sericol 810 | Pin Hole | 2 Rank 4 | 2 Rank 2 | 1 Rank 4 |
| Clear | Dot | 3 | 3 | 5 |
| | Mottling | 4 | 2 | 4 |
| Rank 4 | Density | 4 | 2 | 4 |

The ranking of each material and coating by attribute (pin hole, dot, mottling, and density) was made by visual observation and ordering the highest quality as 1 and the lowest as 6. All categories were equally weighted and the four attributes averaged for each sample. This resulted in a ranking by material for each coating. The three rankings by material for each coating were then averaged to yield an overall ranking of the coating.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

What is claimed is:

1. A coated substrate suitable for inkjet printing comprising:
a non-inkjet ready substrate; and
a coating providing a surface to which inkjet ink adheres with a selectable and substantially consistent texture and gloss level across the surface of the substrate.

2. The coated substrate of claim 1, wherein the texture and gloss level are substantially independent of substrate material or ink density.

3. The coated substrate of claim 1, wherein the coating is cured or dried.

4. The coated substrate of claim 3, wherein the substrate is clear.

5. The coated substrate of claim 3, wherein the substrate is colored.

6. The coated substrate of claim 3, wherein the coating is clear.

7. The coated substrate of claim 3, wherein the coating is colored.

8. The coated substrate of claim 3, wherein the coating comprises a polymer.

9. The coated substrate of claim 3, wherein the coating comprises a solvent.

10. The coated substrate of claim 3, wherein the substrate comprises paper or film.

11. The coated substrate of claim 10, wherein the film comprises polyethylene, polypropylene, polyester or polyolefin.

12. The coated substrate of claim 1, wherein the coating is applied to the substrate by spraying, dipping or flexographic coating.

13. The coated substrate of claim 1, further comprising an image comprising inkjet ink.

14. A method of making a non-inkjet ready substrate suitable for inkjet printing comprising:
providing a non-inkjet ready substrate; and
applying a coating to the substrate, the coating providing a surface to which inkjet ink adheres with a selectable and substantially consistent texture and gloss level across the surface of the substrate.

15. The coated substrate of claim 14, wherein the texture and gloss level are independent of substrate material or ink density.

16. The method of claim 14, further comprising a step of curing or drying after the step of applying.

17. The method of claim 16, wherein the substrate is clear.

18. The method of claim 16, wherein the substrate is colored.

19. The method of claim 16, wherein the coating is clear.

20. The method of claim 16, wherein the coating is colored.

21. The method of claim 16, wherein the coating comprises a polymer.

22. The method of claim 16, wherein the coating comprises a solvent.

23. The method of claim 16, wherein the substrate comprises paper or film.

24. The method of claim 23, wherein the film comprises polyethylene, polypropylene, polyester or polyolefin.

25. The method of claim 14, wherein the step of applying a coating comprises spraying, dipping or flexographic coating.

26. A method of inkjet printing with a non-inkjet ready substrate comprising:
providing a non-inkjet ready substrate;
applying a coating to the substrate, the coating providing a surface to which inkjet ink adheres with a selectable and substantially consistent texture and gloss level across the surface of the substrate; and
applying inkjet ink to the coating to form a printed image.

27. The coated substrate of claim 26, wherein the texture and gloss level are independent of substrate material or ink density.

28. The method of claim 26, further comprising a step of curing or drying after the step of applying.

29. The method of claim 28, wherein the substrate is clear.

30. The method of claim 28, wherein the substrate is colored.

31. The method of claim 28, wherein the coating is clear.

32. The method of claim 28, wherein the coating is colored.

33. The method of claim 28, wherein the coating comprises a polymer.

34. The method of claim 28, wherein the coating comprises a solvent.

35. The method of claim 28, wherein the substrate comprises paper or film.

36. The method of claim 35, wherein the film comprises polyethylene, polypropylene, polyester or polyolefin.

37. The method of claim 26, wherein the step of applying a coating comprises spraying, dipping or flexographic coating.

38. An apparatus for inkjet printing with non-inkjet ready substrates comprising:
a coating station adapted to coat the non-inkjet substrates with a coating that provides a surface to which inkjet ink adheres with a selectable and substantially consistent texture and gloss level across the surface of the substrate; and
a printing station adapted to apply inkjet ink to coated non-inkjet substrates.

39. The apparatus of claim 38, wherein the texture and gloss level are independent of substrate material or ink density.

40. A method of selecting a coating to providing a surface to which inkjet ink adheres with a selectable and substantially consistent texture and gloss level across the surface of a non-inkjet ready substrate comprising:
determining a desired adherence of the ink to the coating;
determining a desired finish.

41. The method of claim 40, wherein determining the desired finish comprises determining a desired surface tension and a desired wetting of the ink on the coating.

42. The method of claim 41, further comprising determining a desired scuff resistance and a desired light degradation of the ink on the coating.
